(19) United States
(12) Patent Application Publication
(10) Pub. No.: US 2009/0162742 A1
(43) Pub. Date: Jun. 25, 2009

(54) PORTABLE APPARATUS

(75) Inventors: Shinya Aikawa, Sagamihara-shi (JP); Michiharu Kanai, Isesaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/247,737

(22) Filed: Oct. 8, 2008

(30) Foreign Application Priority Data
Dec. 21, 2007 (JP) 2007-331086

(51) Int. Cl. H01M 2/10

(52) U.S. Cl. 429/100

(57) ABSTRACT

According to one embodiment, a portable apparatus has a battery casing containing a battery, a main body casing capable of pivoting at the battery casing and having a display unit, and a hinge mechanism provided between the main body casing and the battery casing to connect the main body casing and the battery casing. The hinge mechanism has a cylindrically shaped shaft portion formed integrally with the battery casing to project from the battery casing, an opening portion provided on the main body casing to allow the shaft portion to pass therethrough, an edge portion limiting the surrounding of the opening portion, a detachment stopping portion provided on the shaft portion to engage with the edge portion, and a bearing structure supporting the shaft portion to allow it to rotate.

### CROSS-REFERENCE TO RELATED APPLICATIONS

This application is based upon and claims the benefit of priority from Japanese Patent Application No. 2007-331086, filed Dec. 21, 2007, the entire contents of which are incorporated herein by reference.

### BACKGROUND

1. Field

One embodiment of the present invention relates to a portable apparatus capable of storing and reproducing, for example, music data and image data.

2. Description of the Related Art

Japanese Utility Model Application No. 7-16218 discloses a laptop-type word processor equipped with a keyboard. The laptop-type word processor comprises, at its hinge, a projecting portion having an uneven surface, a rotary shaft provided at a display unit foot, a rotary disc having an uneven surface, a plate spring urging the rotary disc toward the projecting portion, and a horseshoe-shaped E ring. In the laptop-type word processor, the rotary shaft and the rotary disc are molded from resin but, in general, the projecting portion, the rotary shaft, an engaging disc and the plate spring are often formed of metal from the viewpoint of maintaining the strength.

In this laptop-type word processor, an engaging force of the projecting portion and the engaging disc is set to be slightly greater than the rotary force caused by the self weight of the display unit. For this reason, if a rotary force slightly greater than the engaging force is applied, the engaging portion can slide and open and close the display unit.

Incidentally, in the conventional laptop-type word processor, the structure of the hinge portion becomes complicated and the number of components is increased. In addition, if metal parts are used as the projecting portion, the rotary shaft, engaging plate and the plate spring to maintain the strength at the hinge portion, the weight of the laptop-type word processor may be increased.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing a portable apparatus according to a first embodiment;

FIG. 2 is an exemplary perspective view showing an inner structure of the portable apparatus shown in FIG. 1;

FIG. 3 is an exemplary exploded perspective view of the portable apparatus shown in FIG. 2;

FIG. 4 is an exemplary cross-sectional view showing the portable apparatus shown in FIG. 2 as seen along a vertical direction;

FIG. 5 is an exemplary cross-sectional view showing a main body casing of the portable apparatus shown in FIG. 4, as pivoted upwardly at 30 degrees;

FIG. 6 is an exemplary cross-sectional view showing the main body casing of the portable apparatus shown in FIG. 5, as pivoted upwardly at 60 degrees;

FIG. 7 is an exemplary cross-sectional view showing the main body casing of the portable apparatus shown in FIG. 5, as pivoted upwardly at 90 degrees;

FIG. 8 is an exemplary side view showing the main body casing of the portable apparatus shown in FIG. 1, arranged in a lateral direction;

FIG. 9 is an exemplary side view showing the main body casing of the portable apparatus shown in FIG. 8, as pivoted upwardly at 30 degrees;

FIG. 10 is an exemplary side view showing the main body casing of the portable apparatus shown in FIG. 8, as pivoted upwardly at 60 degrees;

FIG. 11 is an exemplary side view showing the main body casing of the portable apparatus shown in FIG. 8, as pivoted upwardly at 70 degrees; and

FIG. 12 is an exemplary side view showing the main body casing of the portable apparatus shown in FIG. 8, as pivoted upwardly at 90 degrees.

### DETAILED DESCRIPTION

Various embodiments according to the invention will be described hereinafter with reference to the accompanying drawings. In general, according to one embodiment of the invention, a portable apparatus has a battery casing containing a battery, a main body casing capable of pivoting at the battery casing and having a display unit, and a hinge mechanism provided between the main body casing and the battery casing to connect the main body casing and the battery casing. The hinge mechanism has a cylindrically shaped shaft portion formed integrally with the battery casing to project from the battery casing, an opening portion provided on the main body casing to allow the shaft portion to pass therethrough, an edge portion limiting the surrounding of the opening portion, a detachment stopping portion provided on the shaft portion to engage with the edge portion, and a bearing structure supporting the shaft portion to allow it to rotate.

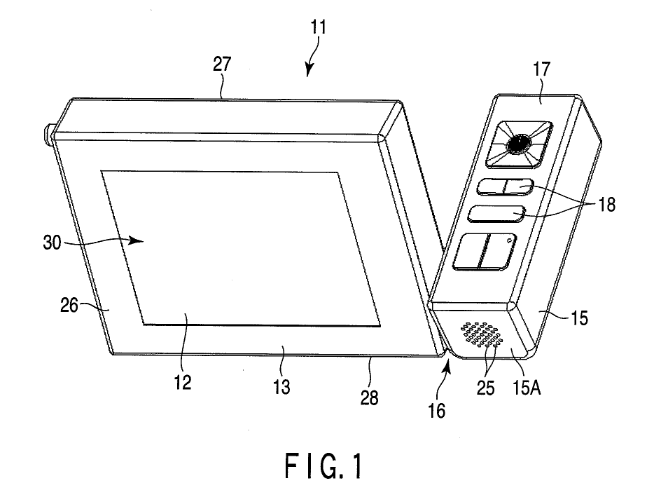

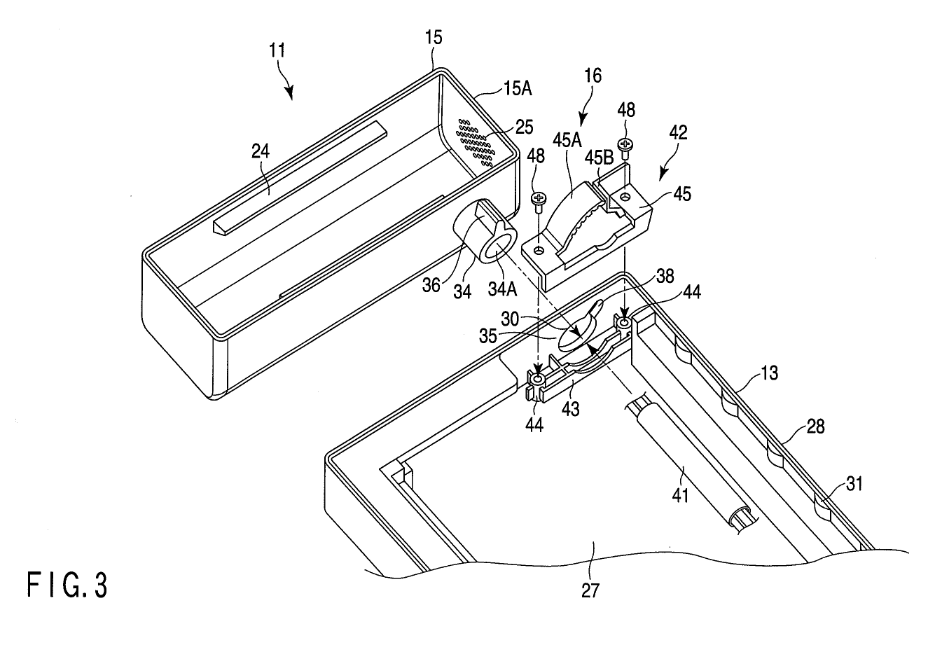

An embodiment of the portable apparatus will be described with reference to FIG. 1 to FIG. 12. The portable apparatus is capable of storing music data and image data in a memory device such as a built-in hard disc and reproducing them arbitrarily.

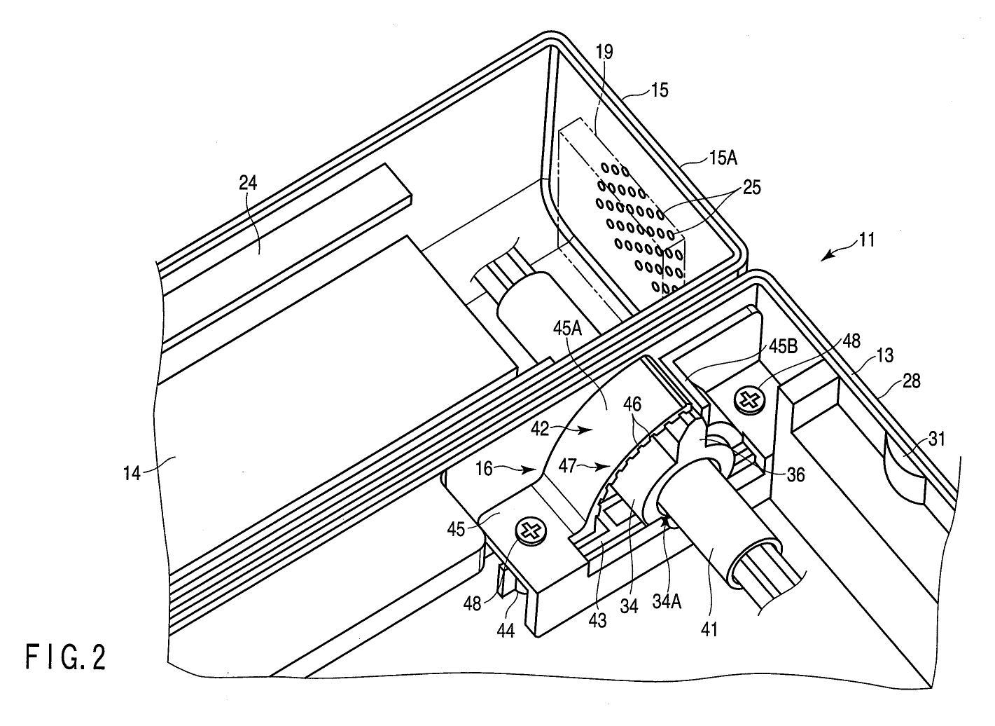

As shown in FIG. 1 and FIG. 2, a portable apparatus 11 comprises a main body casing 13 which contains a liquid crystal display 12 serving as a display unit, a battery casing 15 which contains a battery 14, and a hinge mechanism 16 which is provided between the main body casing 13 and the battery casing 15 to connect the main body casing 13 and the battery casing 15. The main body casing 13 can be pivoted at the battery casing 15 by the function of the hinge mechanism 16.

The battery casing 15 is formed of, for example, synthetic resin in a shape of a box. The battery casing 15 comprises a lid member 17 on a top portion, and the lid member 17 has a plurality of buttons 18 for operation of the portable apparatus 11. In the battery casing 15, the battery 14 serving as a power supply and a speaker 19 are contained. In the battery casing 15, too, a receiving member 24 which receives the lid member 17 is provided. The battery casing 15 further has a front face 15A, and a plurality of through holes 25 are provided on the front face 15A. Speech generated from the speaker 19 can be transmitted to the outside through the through holes 25.

The main body casing 13 is formed of, for example, synthetic resin in a shape of a square box. The main body casing 13 contains a printed circuit board, the liquid crystal display 12, and a hard disk drive. The main body casing 13 comprises a top face portion 26 where the liquid crystal display 12 serving as a display unit is arranged, a bottom face portion 27 which is opposite to the top face portion 26, a front face portion 28 continuous with the top face portion 26 and the bottom face portion 27, and a boundary portion 29 provided between the bottom face portion 27 and the front face portion 28. The top face portion 26 is formed of a lid, and has an opening portion 30 to expose the liquid crystal display 12 to the outside. The main body casing comprises a receiving portion 31 which receives the top face portion 26, i.e., the lid. The boundary portion 29 is oblique to the bottom face portion 27 and the front face portion 28.

The hinge mechanism 16 is arranged in the vicinity of the front face portion 28. The hinge mechanism 16 comprises a shaft portion 34 formed integrally with the battery casing 15 to project from the battery casing 15, the opening portion 30 formed on the main body casing 13 to allow the shaft portion 34 to pass therethrough, an edge portion 35 which regulates the surrounding of the opening portion 30, a detachment stopping portion 36 which is provided at the shaft portion 34 to engage with the edge portion 35, a bearing structure 42 which supports the shaft portion 34 so as to allow the shaft portion 34 to rotate, and a cutaway portion 38 formed integrally with the opening portion 30. The shaft portion 34 is formed in a cylindrical shape. The shaft portion 34 has a through-hole 34A through which a cable 41 passes, at a central portion thereof. The cutaway portion 38 is shaped to be complementary with the detachment stopping portion 36, and is formed to urge the detachment stopping portion 36 to pass inside the main body casing 13.

The bearing structure 42 comprises a rib member 43 which rises from the bottom face portion 27 of the main body casing 13 in a direction orthogonal to the bottom face portion 27, a boss member 44 formed on the bottom face portion 27 of the main body casing 13, and a holder member 45 fixed on the boss member 44. The boss member 44 is arranged adjacent to the rib member 43. The holder member 45 is fixed to the boss member 44 by a screw such that the shaft portion 34 is sandwiched between the rib member 43 and the holder member 45. The holder member 45 comprises an arc-shaped portion 45A, and a stopper portion 45B which extends in a longitudinal direction. The stopper portion 45B covers the cutaway portion 38 when the holder member 45 is fixed to the boss member 44. Groove portions 46 are formed on the arc-shaped portion 45A in increments of, for example, 15 degrees. In other words, a holding mechanism 47 which holds the main body casing 13 at a predetermined installation angle is provided between the detachment stopping portion 36 and arc-shaped portion 45A of the holder member 45. The main body casing 13 is held by the holding mechanism 47 in increments of 15 degrees. The holder member 45 is fixed on the boss member 44 by a screw 48.

In this embodiment, the shaft portion 34 is provided integrally with the battery casing 15, the opening portion 30 is provided at the main body casing 13, and the shaft portion 34 is fixed by the holder member 45 inside the main body casing 13. However, the shaft portion 34 may be provided integrally with the main body casing 13, the opening portion 30 may be provided at the battery casing 15, and the shaft portion 34 may be fixed by the holder member 45 inside the battery casing 15. In addition, the holder member 45 fixed to the boss member 44 by the screw 48, but may be fixed to the boss member 44 by welding. The number of components can be thereby further reduced.

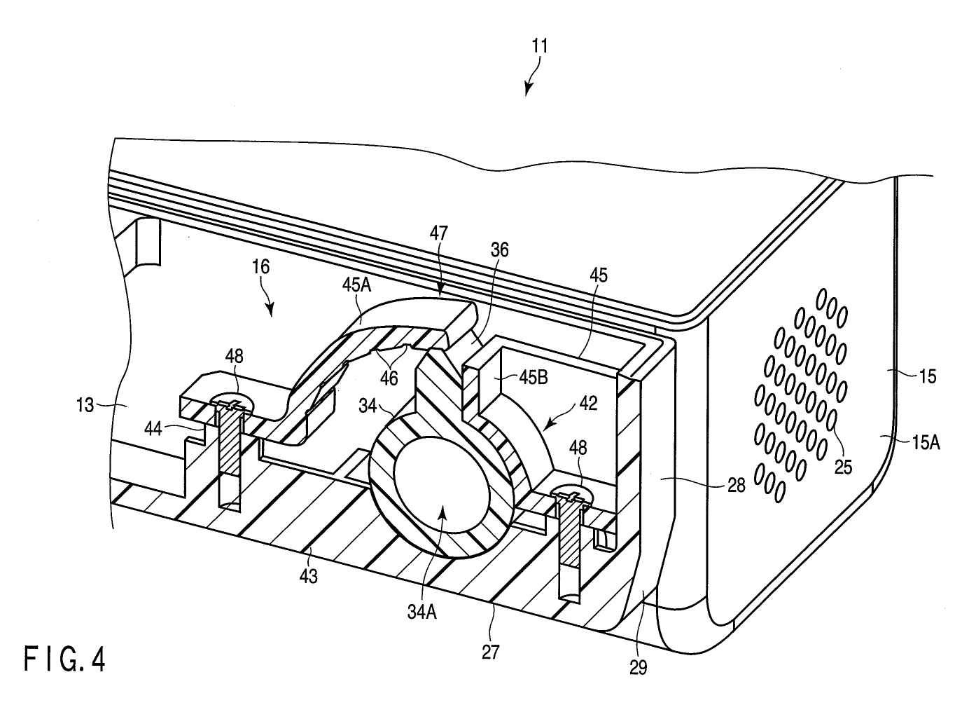

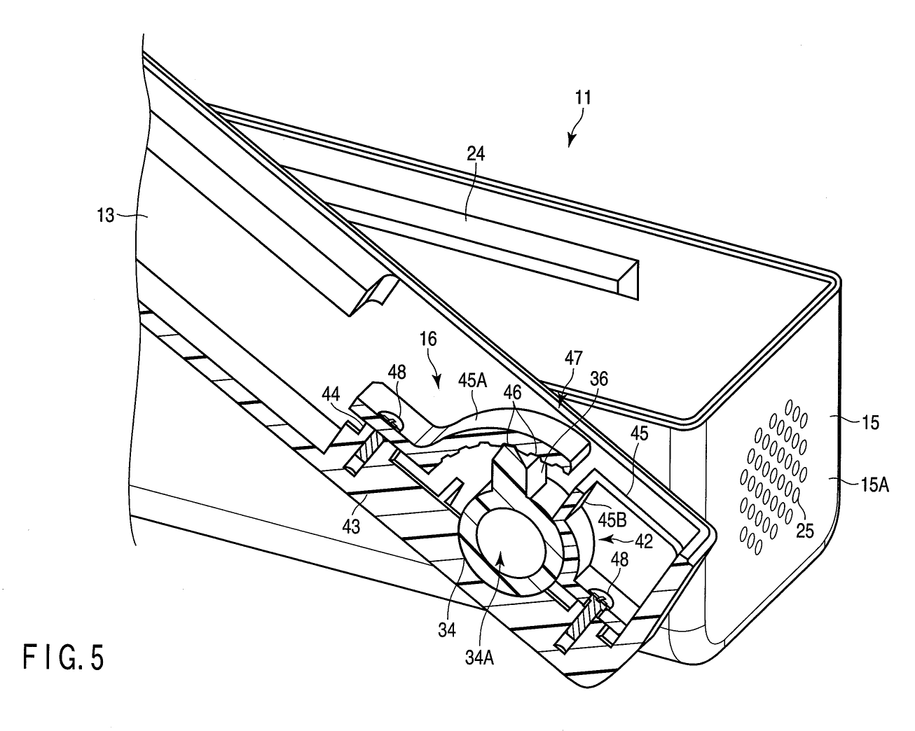

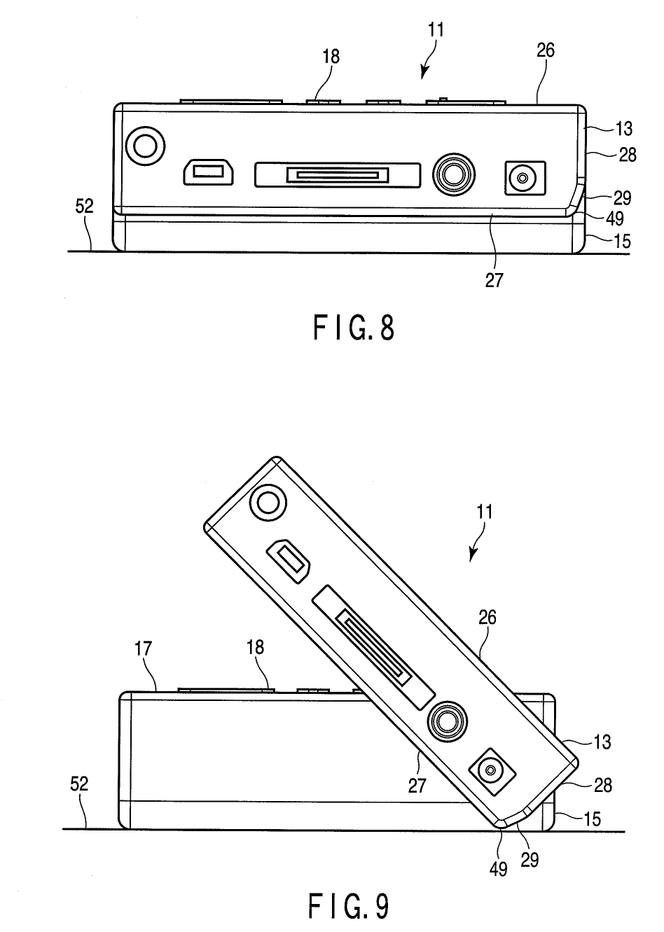

Next, operations for pivoting the main body casing 13 at the battery casing 15 are described with reference to FIG. 4 to FIG. 12. In FIG. 4 and FIG. 8, the main body casing 13 and the battery casing 15 are parallel and are arranged laterally. At this time, the detachment stopping portion 36 abuts on the stopper portion 45B of the holder member 45. FIG. 5 and FIG. 9 show pivoting the main body casing 13 in this state at 30 degrees about the shaft portion 34 of the hinge mechanism 16. At this time, the detachment stopping portion 36 is fitted in the third groove portion 46 from the right.

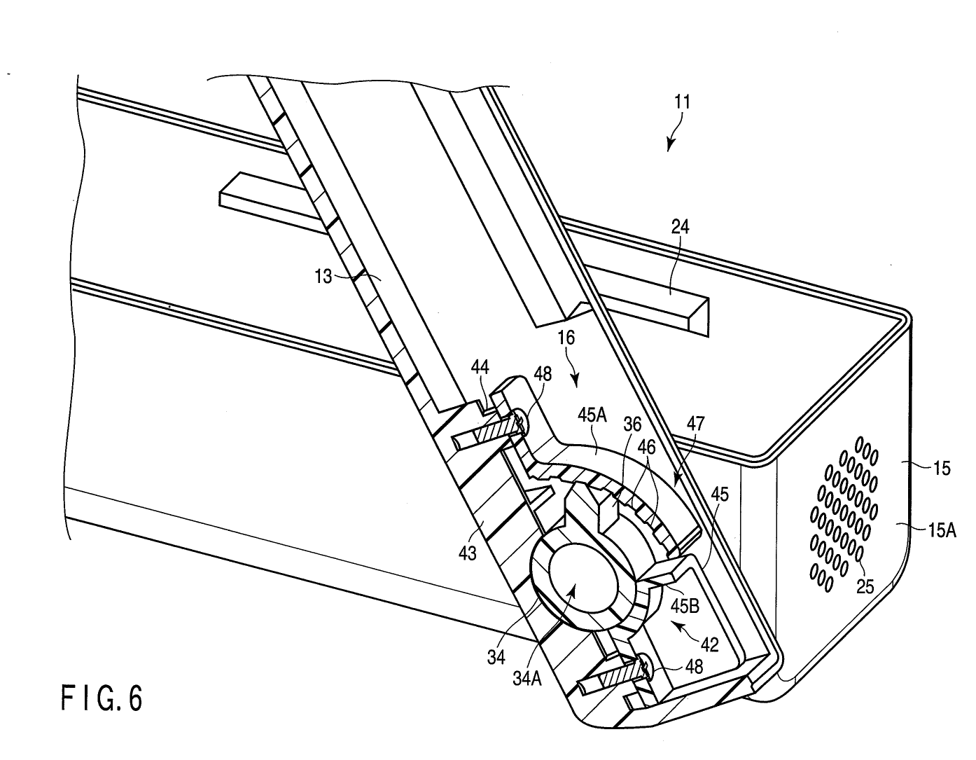

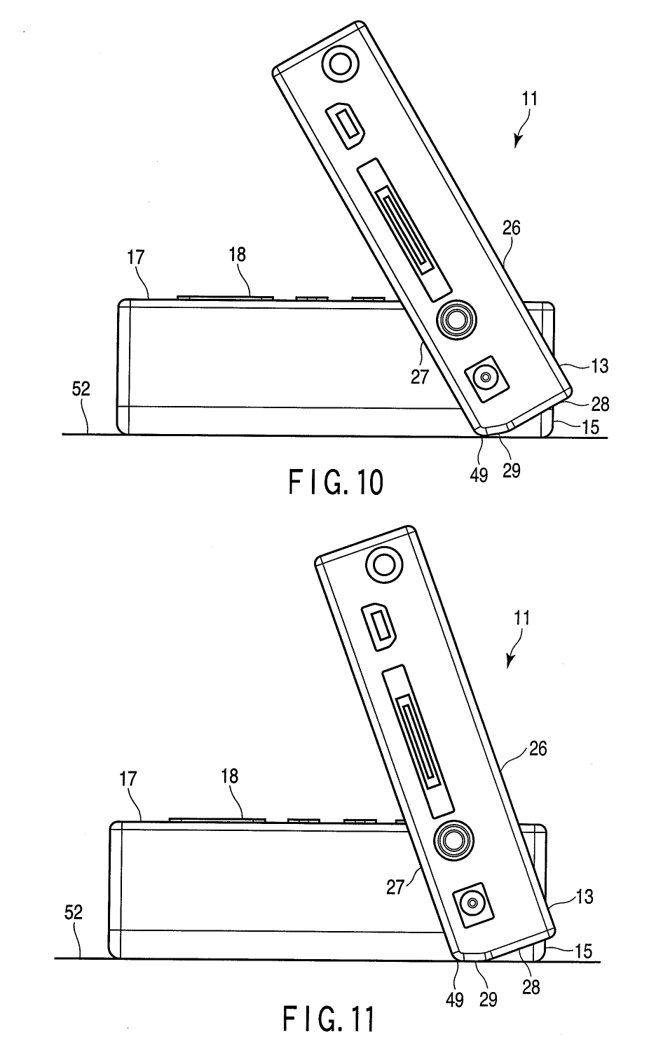

FIG. 6 and FIG. 10 show pivoting the main body casing 13 at 60 degrees from the position shown in FIG. 4. At this time, the detachment stopping portion 36 is fitted in the third groove portion 46 from the right. As shown in FIG. 10, the boundary portion 29 of the main body casing 13 is in contact with an installation plane 52 on which the portable apparatus 11 is installed, at an angular portion 49 of the boundary portion 29. At this time, the boundary portion 29 is in contact with the installation plane 52, but is set not to contact the installation plane 52 when the main body casing 13 is pivoted.

FIG. 11 shows pivoting the main body casing 13 at 70 degrees from the position shown in FIG. 4. At this time, the boundary portion 29 is in contact with the installation plane 52. Since the boundary portion 29 is in surface contact with the installation plane 52, the attitude of the portable apparatus 11 is stable.

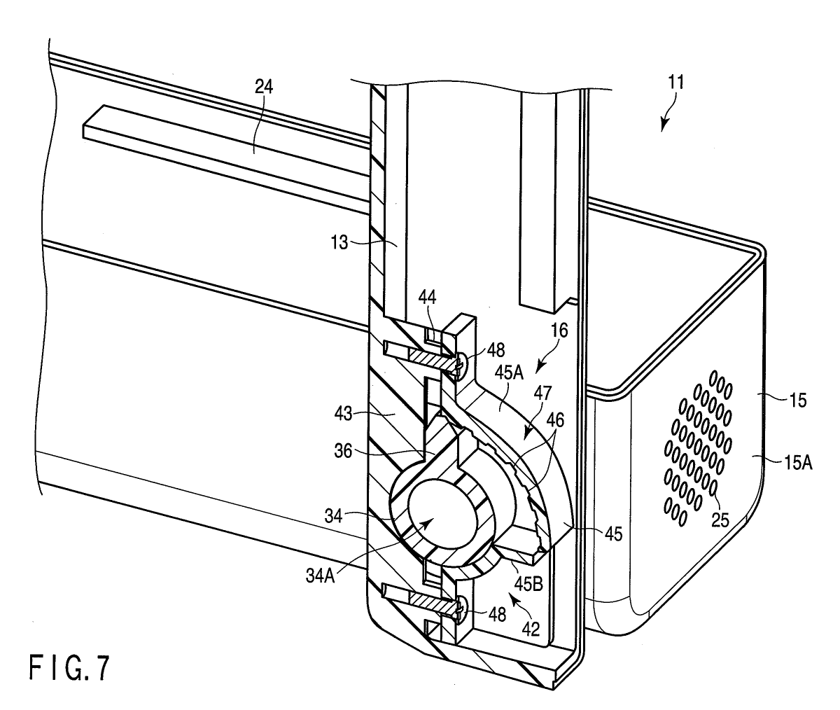

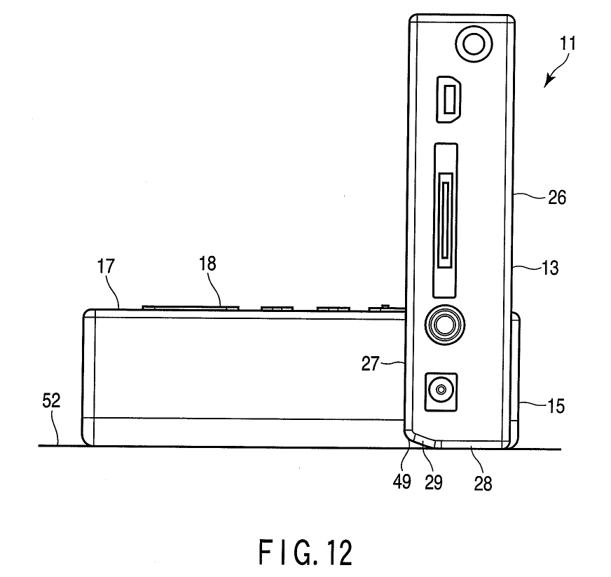

FIG. 7 and FIG. 12 show pivoting the main body casing 13 at 90 degrees from the position shown in FIG. 4. At this time, the detachment stopping portion 36 abuts on the rib member 43 and is fitted in the rightmost groove portion 46. Simultaneously, the front face portion 28 of the main body casing 13 is in surface contact with the installation plane 52. For this reason, the attitude of the portable apparatus 11 is stable in this state. As explained above, in the portable apparatus 11 of this embodiment, the boundary portion 29 is in contact with the installation plane 52 when the main body casing 13 is arranged in a range of what is called angle of use, from the position at which the main body casing 13 is arranged upright to the position at which the main body casing 13 arranged laterally is pivoted upward at 60 degrees. At this time, the main body casing 13 oblique to the installation plane 52 at the position at which the main body casing 13 arranged laterally is pivoted upward at 60 degrees.

Described above is the embodiment of the portable apparatus 11. According to this embodiment, the portable apparatus 11 comprises the battery casing 15 which contains the battery 14, the main body casing 13 which can pivot at the battery casing 15 and has the display unit, and the hinge mechanism 16 which is provided between the main body casing 13 and the battery casing 15 to connect the main body casing 13 and the battery casing 15. The hinge mechanism 16 comprises the cylindrically shaped shaft portion 34 formed integrally with the battery casing 15 to project from the battery casing 15, the opening portion 30 formed on the main body casing 13 to allow the shaft portion 34 to pass therethrough, the edge portion 35 which regulates the surrounding of the opening portion 30, the detachment stopping portion 36 which is provided at the shaft portion 34 to engage with the edge portion 35, and the bearing structure 42 which supports the shaft portion 34 so as to allow the shaft portion 34 to rotate.

According to this structure, the structure in which the battery casing 15 and the main body casing 13 are provided separately and the main body casing 13 can pivot via the hinge mechanism 16 can be implemented easily. In particular, since the shaft portion 34 of the hinge mechanism 16 is formed integrally with the battery casing 15, the number of components can be reduced as compared with a case where the shaft portion 34 is prepared independently. If the main body casing 13 and the battery casing 15 are formed of synthetic resin, metal components do not need to be used and the weight of the portable apparatus 11 can be reduced. In this case, the shaft portion 34 comprises the through-hole 34A through which the cable 41 passes, at the central portion. In this structure, the cable 41 can be arranged inside the hinge mechanism 16, space for arranging the casing 41 is not required especially, and the portable apparatus 11 can be downsized.

In this case, the bearing structure 42 comprises the rib member 43 which rises from the bottom face portion 27 of the main body casing 13, the boss member 44 formed on the bottom face portion 27 of the main body casing 13, and the holder member 45 fixed on the boss member 44 such that the shaft portion 34 is sandwiched between the holder member 45 and the rib member 43. In this structure, the shaft portion 34 can be supported stably by the rib member 43 and the holder member 45.

In this case, the main body casing 13 comprises the cutaway portion 38 which is formed integrally with the opening portion 30 to allow the detachment stopping portion 36 to pass therethrough. The holder member 45 covers the cutaway portion 38 when the holder member 45 is fixed on the boss member 44. This structure can prevent the detachment stopping portion 36 from being detached unintentionally from the edge portion 35 via the cutaway portion 38.

In this case, the holding mechanism 47 which holds the main body casing 13 at a predetermined installation angle is provided between the detachment stopping portion 36 and the holder member 45. According to this structure, the portable apparatus 11 can be used while fixing the main body casing 13 comprising the display unit at a desired angle. The hinge mechanism 16 can serve as the holding mechanism 47, and the space required for installation can be reduced as compared with a case of providing the holding mechanism 47 independently.

In this case, the main body casing 13 comprises the top face portion 26 where the liquid crystal display is arranged, the bottom face portion 27 which is opposite to the top face portion 26, the front face portion 28 provided continuously with the top face portion 26 and the bottom face portion 27, and the boundary portion 29 provided between the bottom face portion 27 and the front face portion 28. The hinge mechanism 16 is arranged in the vicinity of the front face portion 28. The boundary portion 29 is in contact with the installation plane 52 when the main body casing 13 is within a predetermined range of the angle of use. According to this structure, the boundary portion 29 of the main body casing 13 is in contact with the installation plane 52 when the portable apparatus 11 is used. For this reason, the attitude of the portable apparatus 11 can be stabilized when the main body casing 13 is within the range of the angle of use.

In this case, the predetermined range of the angle of use corresponds to the range from a position at which the main body casing 13 is arranged upright to a position at which the main body casing 13 is oblique to the installation plane 52. In this structure, the boundary portion 29 can be made to contact the installation plane 52 and the attitude of the portable apparatus 11 can be stabilized, at an angle which is expected to be used mainly. The range of the angle of use is expected to be from a position at which the main body casing 13 in the laterally arranged state is made to pivot upward at 60 degrees to a position at which the main body casing 13 stands upright.

In this case, the boundary portion 29 is oblique to the front face portion 28 and the bottom face portion 27. According to this structure, a configuration wherein the boundary portion 29 is in contact with the installation plane 52 within the predetermined range of the angle of use while the boundary portion 29 and the installation plane 52 do not interfere with each other when the main body casing 13 pivots beyond the range of the angle of use, can be implemented.

In this case, the battery casing 15 contains the speaker 19. The battery casing 15 comprises the front face 15A, and a plurality of through-holes 25 provided on the front face 15A such that speech is transmitted from the speaker 19 to the outside through the plurality of through-holes 25. In this structure, the through-holes 25 can be arranged to face forward irrespective of the installation angle of the main body casing 13. It is thereby possible to prevent occurrence of a problem that the speech is hardly heard according to the position where the main body casing 13 is installed.

The portable apparatus 11 of this invention can be applied not only to portable music/image players, but also to electronic devices such as cellular telephones and portable computers. The portable apparatus can also be variously modified within a scope which does not depart from the gist of the present invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A portable apparatus comprising:
a battery casing comprising a battery;
a main body casing capable of pivoting at the battery casing and comprising a display; and
a hinge provided between the main body casing and the battery casing, and configured to connect the main body casing and the battery casing,
wherein the hinge comprises:
a cylindrical shaft portion formed integrally with the battery casing projecting from the battery casing;
an opening portion provided at the main body casing, and configured to allow the shaft portion to pass therethrough;
an edge portion configured to regulate surrounding of the opening portion;
a detachment stopping portion provided on the shaft portion engaging with the edge portion; and
a bearing mechanism configured to support the shaft portion and to allow the shaft portion to pivot.

2. The portable apparatus of claim 1, wherein the shaft portion comprises a through-hole through which a cable passes, at a central portion of the shaft portion.

3. The portable apparatus of claim 2, wherein the bearing mechanism comprises:
a rib projection rising from a bottom face portion of the main body casing;
a boss portion formed on the bottom face portion of the main body casing; and
a holder fixed at the boss portion in order to allow the shaft portion to be sandwiched between the holder and the rib projection.

4. The portable apparatus of claim 3, wherein the main body casing comprises a cutaway portion formed integrally with the opening portion in order to allow the detachment stopping portion to pass through the cutaway portion, and the holder is configured to close the cutaway portion when fixed on the boss portion.

5. The portable apparatus of claim 4, further comprising a holding mechanism configured to hold the main body casing at a predetermined installation angle, between the detachment stopping portion and the holder.

6. The portable apparatus of claim 5, wherein the main body casing comprises:
a top face portion on which the display is arranged;
the bottom face portion provided opposite to the top face portion;
a front face portion continuous with the top face portion and the bottom face portion; and
a boundary portion provided between the bottom face portion and the front face portion, and
wherein the hinge mechanism is arranged in vicinity of the front face and the boundary portion is in contact with an installation face when the main body casing is within a predetermined range of an angle of use.

7. The portable apparatus of claim 6, wherein the predetermined range of the angle of use is configured to correspond to a range from a position at which the main body casing is arranged upright to a position at which the main body casing is oblique to the installation face.

8. The portable apparatus of claim 7, wherein the boundary portion is oblique to the front face portion and the bottom face portion.

9. The portable apparatus of claim 8, further comprising a speaker contained inside the battery casing, the battery casing comprising a front face and a plurality of through-holes provided on the front face, the speaker configured to transmit speech from the plurality of through-holes to outside.
